(19) United States
(12) Patent Application Publication
(10) Pub. No.: US 2005/0003948 A1
(43) Pub. Date: Jan. 6, 2005

(54) Optical glass

(75) Inventor: Takahiro Yamazaki, Yotsukaido-shi (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: HIKARI GLASS CO., LTD.

(21) Appl. No.: 10/852,431

(22) Filed: May 25, 2004

(30) Foreign Application Priority Data
Dec. 4, 2002 (JP) 2002-352541

(51) Int. Cl. C03C 3/16

(52) U.S. Cl. 501/45

(57) ABSTRACT

An optical glass suitable for high-precision lenses moldable at a low temperature, and having a transformation temperature (Tg) of 340° C.-430° C. and excellent chemical durability, is provided by compositions that include Na₂O, ZnO, P₂O₅, and Sb₂O₃, and optionally include K₂O, CaO, BaO, SrO, and MgO—each within a specified wt % range.

### BACKGROUND OF THE INVENTION

This invention relates to an optical glass, and more particularly to an optical glass that is moldable at a low temperature for use as optical lenses, that has excellent chemical durability, and that contains substantially no lithium.

Optical glasses made of a P₂O₅—B₂O₃—Nb₂O₅-alkaline metal-oxide base (Japanese Unexamined Published Patent Application No. S52-132012), a P₂O₅—Nb₂O₅-alkaline metal-oxide base (Japanese Unexamined Published Patent Application No. S54-132925), and a P₂O₅—Sb₂O₃-base (Japanese Unexamined Published Patent Application No. S60-40839) are disclosed. Those optical glasses, however, require a temperature higher than 500° C. for press-molding. When press-molding is performed repeatedly at such a high temperature, the mold dies are so easily damaged that the dies have to be replaced frequently in order to secure economical mass-production while meeting the surface-properties requirements of the precision glass that is to be manufactured. Decreasing the deforming temperature of optical glasses, therefore, is desired in order to improve production efficiency.

Low-melting-temperature phosphate optical glasses have been proposed as a Li₂O—Na₂O—ZnO—P₂O₅-based glass (Japanese Unexamined Published Patent Application No. H04-231345) and as a P₂O₅—B₂O₃—Nb₂O₅—Li₂O—Na₂O—SiO₂-based glass (Japanese Unexamined Published Patent Application No. H08-157231). They have attained the aforementioned desired goal by adding Li₂O to the composition. However, Li₂O is not an appropriate component for a high-precision press-molding composition, because it easily evaporates under molding conditions and adheres to the molding dies. Such adhesion to the molding dies is disadvantageous for precision press-molding.

As a result, the addition of Ag₂O or Tl₂O in place of Li₂O has been proposed (Japanese Unexamined Published Patent Application No. H07-165436, and Japanese Unexamined Published Patent Application No. H07-267673). However, the addition of large amounts of Ag₂O or Tl₂O, damages the chemical durability and weathering resistance of the glass.

Under these circumstances, there has been a strong need for economical optical-glass compositions that have a low deforming temperature while satisfying other physical-properties requirements for optical glass.

### SUMMARY OF THE INVENTION

The primary object of the present invention is to provide an optical glass that has a transformation temperature (Tg) of 340° C.-430° C. without including Li₂O, Ag₂O, or Tl₂O.

Another object of the present invention is to provide an optical glass that has excellent chemical durability while maintaining a transformation temperature (Tg) within the above-mentioned temperature range.

These objects are achieved by providing an optical glass that includes:

(a) Na₂O in an amount ranging from 4 wt % to 12 wt % of said optical glass (hereinafter

(b) ZnO in an amount ranging from 9 wt % to 38 wt %;

(c) P₂O₅ in an amount ranging from 38 wt % to 57 wt %; and

(d) Sb₂O₃ in an amount ranging from 2 wt % to 17 wt %.

These objects are also achieved by providing an optical glass that includes:

(a) Na₂O in an amount ranging from 4 wt % to 12 wt %, or Na₂O and K₂O together in a total combined amount ranging from 4 wt % to 12 wt % under the condition that K₂O is in an amount less than 7 wt %;

(b) ZnO and oxides selected from CaO, BaO, SrO, and MgO together in a total combined amount ranging from 21 wt % to 45 wt % of said optical glass under the condition that ZnO is in a range of 9 wt % to 38 wt % and said oxides are 9 wt % or less of CaO, 31 wt % or less of BaO, 15 wt % or less of SrO, and 8 wt % or less of MgO;

(c) P₂O₅ in an amount ranging from 38 wt % to 57 wt %; and

(d) Sb₂O₃ in an amount ranging from 5 wt % to 17 wt %.

### DESCRIPTION OF THE PRESENT INVENTION

Optical glass that has a transformation temperature (Tg) of 340 ° C.-430° C. according to the present invention includes Na₂O, ZnO, P₂O₅, Sb₂O₃, and further optionally can include K₂O, CaO, BaO, SrO, and MgO—each within a specified wt % range.

Each of these components has different functions in optical glass. The specific combination of the components can bring about specific properties in this invention, as described below. Thus, the ratios of these components are determined based on a subtle balance of the components for each composition. In other words, satisfactory optical glass can be obtained only when all of these components are well-balanced within the ranges mentioned above.

Both Na₂O and K₂O lower the transformation temperature of optical glass. For the embodiments of the present invention, the amount of those components in the optical glass will be 4 wt % to 12 wt % for Na₂O or a combined total amount of Na₂O and K₂O under the condition that K₂O is less than 7 wt %. An amount less than the above-mentioned amounts will tend to be not enough to lower the transformation temperature (Tg) of the optical glass. An amount in excess of those amounts will tend to reduce the glass's chemical durability, and will tend to devitrify the glass and make high-precision molding difficult by sticking a part of evaporated glass to the molding dies during the press-molding.

ZnO lowers the transformation temperature, increases the devitrification resistance of the glass, and serves to adjust the refractive index as intended. For the embodiments of the present invention, the amount of ZnO in the optical glass will be 9 wt % to 38 wt %. CaO, BaO, SrO, and MgO also lower the transformation temperature, increase the glass's devitrification resistance, and serve to adjust the refractive index. A part of ZnO, therefore, can be replaced by any of CaO, BaO, SrO, or MgO. If one or more of those oxides is added, the total amount of ZnO and the oxides will be 21 wt % to 45 wt % under the conditions that the amount of ZnO is 9 wt % to 38 wt % and that the additional oxides are 9 wt % or less of CaO, 31 wt % or less of BaO, 15 wt % or less of SrO, and 8 wt % or less of Mg. An amount outside the above-mentioned ranges might reduce the devitrification resistance of the glass.

P₂O₅ is a basic component that builds up the glass structure, lowers the transformation temperature, and improves the devitrification resistance of the glass. For the embodiments of the present invention, the amount of P₂O₅ in the optical glass will be 38 wt % to 57 wt %. An amount less than that might deteriorate the devitrification resistance of the glass, and an amount in excess of that might reduce the chemical durability of the glass.

Sb₂O₃ lowers the transformation temperature, improves the devitrification resistance of the glass, serves to adjust the refractive index, acts as a defoamer of the molten mixture for the compositions of the optical glass, and contributes to a uniform molten mixture. For the embodiments of the present invention, the amount of Sb₂O₃ in the optical glass will be 2 wt % to 17 wt %, preferably within the range of 5 wt % to 17 wt %. An amount less than the aforementioned will tend to enough to lower the transformation temperature of the optical glass or to reduce defoaming of the molten mixture during the manufacturing process. An amount in excess of the aforementioned might reduce the devitrification resistance of the glass.

In addition to the components mentioned above, other oxides, such as AM₂O₃, SnO, ZrO₂, TiO₂, Nb₂O₅, Ta₂O₅, WO₃, B₂O₃, La₂O₃, Y₂O₃, and Gd₂O₃, can be added—each within a range that does not have any adverse effects on the invention. The allowable amounts of these additional oxides differ from each other, as mentioned below.

Al₂O₃ improves the devitrification resistance and chemical durability of optical glass. Al₂O₃ can be added to the glass in an amount of less than 4 wt %. An amount in excess of 4 wt % will tend to reduce the devitrification resistance of the glass.

SnO improves the chemical durability of optical glass, and it can be added in an amount less than 2 wt % to the glass. An amount in excess of 2 wt % will tend to reduce the devitrification resistance of the glass.

ZrO₂ improves the chemical durability of optical glass, and it can be added to the glass in an amount less than 1 wt %. An amount in excess of 1 wt % will tend to reduce the devitrification resistance.

TiO₂ is effective in adjusting the refractive index of optical glass, and it can be added to the glass in an amount less than 6 wt %. An amount in excess of 6 wt % will tend to reduce the devitrification resistance of the glass and stain the glass.

Nb₂O₅ also is effective in adjusting the refractive index of optical glass, and it can be added to the glass in an amount less than 15 wt %. An amount in excess of 15 wt % will tend to reduce the devitrification resistance of the glass and stain the glass.

Ta₂O₅ also is effective in adjusting the refractive index of optical glass, and it can be added to the glass in an amount less than 1 wt %. An amount in excess of 1 wt % will tend to reduce the devitrification resistance of the glass.

WO₃ also is effective in adjusting the refractive index of optical glass, and it can be added to the glass in an amount less than 6 wt %. An amount in excess of 6 wt % will tend to reduce the devitrification resistance of the glass and stain the glass.

B₂O₃ improves the chemical durability of optical glass, and it can be added to the glass in an amount less than 3 wt %. An amount in excess of 3 wt % will tend to reduce the devitrification resistance of the glass.

La₂O₃ is effective in adjusting the refractive index of optical glass, and it can be added to the glass in an amount less than 3 wt %. An amount in excess of 3 wt % will tend to reduce the devitrification resistance of the glass.

Y₂O₃ is effective in adjusting the refractive index of optical glass, and it can be added to the glass in an amount less than 2 wt %. An amount in excess of 2 wt % will tend to reduce the devitrification resistance of the glass.

Gd₂O₃ is effective in adjusting the refractive index of optical glass, and it can be added to the glass in an amount less than 3 wt %. An amount in excess of 3 wt % will tend to reduce the devitrification resistance of the glass.

Other oxides, such as SiO₂, Bi₂O₃, Yb₂O₃, and GeO₂, also can be added to the optical glass for the purpose of adjusting the glass's optical performance, improving its meltability, and enlarging its glass-formation area. This invention does not limit the addition of these oxides insofar as they do not have any adverse effect on the invention.

Optical glass according to the invention can be manufactured by any suitable method or manner known in the art. Typically, raw materials, oxides, or precursors to oxides are blended to make the composition as prescribed, after which the composition is heated at 1100° C.-1400° C. so as to make the composition molten. The composition is then agitated to make it uniform, after which the composition is then defoamed and poured into a metallic die for casting.

### EXAMPLES

### Example 1

Glass raw materials, oxides, phosphates, carbonates, nitrates, and the like were blended so as to make the compositions shown in Tables 1-3, mixed well, then put into a platinum pot and then heated in an electrically heated furnace at 1000° C. to 1200° C. for 1 hour to 2 hours. The mixture, after being clarified, was poured into a preheated iron die for casting, and then cooled at a rate of 16° C./hour in order to give optical glass. The refractive index (nd) at the helium d-line, the Abbe number (vd), and the transformation temperature (Tg) were measured by methods well-known in the art. The results are shown in Tables 1-3. In these examples, the transformation temperature (Tg) was measured by raising the temperature by 4° C./min using a thermodilatometer.

TABLE 1
Examples of Glass Compositions and Properties Thereof (Nos. 1-11)

| Examples of Glass Compositions | | | | | | | | | | |
|---|---|---|---|---|---|---|---|---|---|---|
| (wt % of each component) | | | | | | | | | | |
| Examples | | | | | | | | | | |
| No. 1 | No. 2 | No. 3 | No. 4 | No. 5 | No. 6 | No. 7 | No. 8 | No. 9 | No. 10 | No. 11 |

Components

| | | | | | | | | | | | |
|---|---|---|---|---|---|---|---|---|---|---|---|
| Na₂O | 10.4 | 7.0 | 7.8 | 5.0 | 6.9 | 7.7 | 10.0 | 11.4 | 6.5 | 6.1 | 6.6 |
| K₂O | | | 4.8 | 1.7 | 4.5 | 4.3 | 1.4 | | 4.2 | 4.0 | 4.1 |
| ZnO | 26.8 | 32.2 | 37.3 | 32.2 | 21.2 | 11.9 | 20.9 | 18.7 | 18.1 | 17.6 | 18.2 |
| CaO | | | | | 8.1 | | 8.1 | 8.1 | 3.8 | | |
| BaO | | | | | | 30.2 | | 2.2 | 10.3 | 19.7 | 19.5 |
| SrO | | | | | | | | | | | |
| MgO | | | | | | | | | | 4.3 | |
| P₂O₅ | 45.8 | 56.1 | 45.7 | 56.1 | 45.2 | 40.9 | 47.6 | 47.6 | 44.6 | 42.5 | 41.5 |
| Sb₂O₃ | 17.0 | 4.7 | 5.0 | 5.0 | 14.1 | 5.0 | 11.7 | 11.7 | 11.8 | 5.0 | 8.8 |
| Al₂O₃ | | | | | | | 0.3 | 0.3 | 0.7 | 0.8 | 1.3 |
| SnO | | | | | | | | | | | |
| ZrO₂ | | | | | | | | | | | |
| TiO₂ | | | | | | | | | | | |
| Nb₂O₅ | | | | | | | | | | | |
| Ta₂O₅ | | | | | | | | | | | |
| WO₃ | | | | | | | | | | | |
| B₂O₃ | | | | | | | | | | | |
| La₂O₃ | | | | | | | | | | | |
| Y₂O₃ | | | | | | | | | | | |
| Gd₂O₃ | | | | | | | | | | | |
| Properties | | | | | | | | | | | |
| nd | 1.60704 | 1.56516 | 1.58342 | 1.56590 | 1.60161 | 1.59556 | 1.59708 | 1.59626 | 1.60546 | 1.59847 | 1.60205 |
| vd | 46.8 | 56.5 | 53.9 | 56.3 | 50.0 | 55.6 | 50.8 | 50.8 | 50.4 | 55.6 | 52.0 |
| Tg (° C.) | 345 | 351 | 358 | 347 | 366 | 352 | 347 | 358 | 364 | 408 | 358 |

TABLE 2
Examples of Glass Compositions and Properties Thereof (Nos. 12-22)

| | Examples of Glass Compositions | | | | | | | | | | |
|---|---|---|---|---|---|---|---|---|---|---|---|
| | (wt % of each component) | | | | | | | | | | |
| | Examples | | | | | | | | | | |
| ⇓ | No. 12 | No. 13 | No. 14 | No. 15 | No. 16 | No. 17 | No. 18 | No. 19 | No. 20 | No. 21 | No. 22 |

Components

| | | | | | | | | | | | |
|---|---|---|---|---|---|---|---|---|---|---|---|
| Na₂O | 6.3 | 6.3 | 6.1 | 6.1 | 7.7 | 4.4 | 6.4 | 6.2 | 6.2 | 6.3 | 6.3 |
| K₂O | 4.1 | 4.1 | 4.0 | 4.0 | 4.3 | 6.7 | 4.3 | 4.3 | 4.2 | 4.2 | 4.2 |
| ZnO | 14.3 | 14.3 | 17.6 | 17.6 | 11.2 | 32.3 | 18.3 | 14.6 | 15.6 | 18.0 | 18.0 |
| CaO | 3.7 | 3.7 | | | 5.9 | | 3.8 | 5.8 | 3.8 | 3.8 | 3.8 |
| BaO | 10.1 | 10.1 | 19.7 | 19.7 | 4.3 | | 10.4 | 5.3 | 10.3 | 9.4 | 9.4 |
| SrO | 11.6 | 14.6 | | | | | | | | | |
| MgO | | | 7.3 | 4.3 | | | | | | | |
| P₂O₅ | 43.6 | 43.6 | 42.5 | 42.5 | 46.0 | 47.7 | 45.1 | 45.4 | 44.4 | 44.4 | 44.4 |
| Sb₂O₃ | 5.0 | 2.0 | 2.0 | 5.0 | 17.0 | 5.0 | 9.7 | 15.1 | 13.0 | 12.4 | 12.4 |
| Al₂O₃ | 1.3 | 1.3 | 0.8 | 0.8 | 2.2 | 3.9 | 0.6 | 1.9 | 0.5 | 0.5 | 0.5 |
| SnO | | | | | 1.4 | | 1.4 | 1.4 | 2.0 | | |
| ZrO₂ | | | | | | | | | | 1.0 | |
| TiO₂ | | | | | | | | | | | 1.0 |
| Nb₂O₅ | | | | | | | | | | | |
| Ta₂O₅ | | | | | | | | | | | |
| WO₃ | | | | | | | | | | | |
| B₂O₃ | | | | | | | | | | | |
| La₂O₃ | | | | | | | | | | | |
| Y₂O₃ | | | | | | | | | | | |
| Gd₂O₃ | | | | | | | | | | | |
| Properties | | | | | | | | | | | |
| nd | 1.59744 | 1.59026 | 1.59032 | 1.59847 | 1.60843 | 1.58285 | 1.59756 | 1.60925 | 1.60637 | 1.60538 | 1.61161 |
| vd | 55.8 | 58.9 | 58.4 | 55.6 | 47.5 | 54.3 | 51.3 | 48.5 | 49.6 | 49.8 | 46.7 |
| Tg (° C.) | 396 | 402 | 426 | 408 | 375 | 382 | 363 | 383 | 367 | 369 | 367 |

TABLE 3
Examples of Glass Compositions and Properties Thereof (Nos. 23-33)

| | Examples of Glass Compositions | | | | | | | | | | |
|---|---|---|---|---|---|---|---|---|---|---|---|
| | (wt % of each component) | | | | | | | | | | |
| | No. 23 | No. 24 | No. 25 | No. 26 | No. 27 | No. 28 | No. 29 | No. 30 | No. 31 | No. 32 | No. 33 |
| Na₂O | 6.2 | 6.3 | 6.8 | 6.9 | 6.3 | 6.3 | 6.2 | 6.2 | 6.3 | 6.3 | 6.2 |
| K₂O | 4.8 | 4.1 | 4.4 | 4.7 | 4.2 | 4.2 | 4.8 | 4.1 | 4.1 | 4.1 | 4.1 |
| ZnO | 32.1 | 17.8 | 22.7 | 27.2 | 18.0 | 18.0 | 35.1 | 26.8 | 26.9 | 27.0 | 26.8 |
| CaO | | 1.8 | | | 3.8 | 3.8 | | | | | |
| BaO | | 13.7 | 9.7 | | 9.4 | 9.4 | | | | | |
| SrO | | | | | | | | | | | |
| MgO | | | | | | | | | | | |
| P₂O₅ | 47.3 | 43.4 | 41.4 | 41.2 | 44.4 | 44.4 | 43.8 | 43.6 | 43.6 | 43.6 | 43.6 |
| Sb₂O₃ | 5.0 | 10.8 | 6.9 | 5.0 | 12.4 | 12.4 | 5.0 | 16.7 | 17.0 | 17.0 | 17.0 |
| Al₂O₃ | 1.5 | 0.6 | 0.6 | | 0.5 | 0.5 | | | | | |
| SnO | | | | | | | | | | | |
| ZrO₂ | | | | | | | | | | | |
| TiO₂ | 3.1 | | | | | | | | | | |
| Nb₂O₅ | | 1.5 | 7.5 | 15.0 | | | | | | | |
| Ta₂O₅ | | | | | 1.0 | | | | | | |
| WO₃ | | | | | | 1.0 | 5.1 | | | | |
| B₂O₃ | | | | | | | | 2.6 | | | |
| La₂O₃ | | | | | | | | | 2.1 | | |
| Y₂O₃ | | | | | | | | | | 2.0 | |
| Gd₂O₃ | | | | | | | | | | | 2.3 |
| Properties | | | | | | | | | | | |
| nd | 1.60911 | 1.60732 | 1.61596 | 1.64036 | 1.60522 | 1.60495 | 1.59369 | 1.60478 | 1.61132 | 1.61036 | 1.60996 |
| vd | 43.8 | 49.2 | 45.8 | 40.4 | 49.6 | 49.7 | 51.4 | 47.4 | 46.5 | 46.3 | 46.7 |
| Tg (° C.) | 389 | 362 | 380 | 408 | 365 | 362 | 364 | 372 | 351 | 356 | 351 |

The optical glass of the present invention had a transformation temperature (Tg) of as low as 340° C.-430° C.

### Example 2

The refractive index (nd), Abbe number (vd), and transformation temperature (Tg) of one glass composition (Composition No. 25 in Example 1) of this invention and of another glass that did not include any Na₂O and K₂O (glass corresponding to the glass described in Example 30 and in Japanese Unexamined Published Patent Application No. S60-40839) were compared. The results thereof are shown in Table 4.

TABLE 4
A Comparison of a Glass of This Invention with Another Glass

| | | Glass of This | Other Glass |
|---|---|---|---|
| | | Invention | (for comparison) |
| Glass | Na₂O | 6.8 | |
| composition | K₂O | 4.4 | |
| (wt %) | ZnO | 22.7 | 39.0 |
| | BaO | 9.7 | |
| | P₂O₅ | 41.4 | 50.0 |
| | Sb₂O₃ | 6.9 | 6.0 |
| | Al₂O₃ | 0.6 | |
| | Nb₂O₅ | 7.5 | 5.0 |
| Properties | nd | 1.616 | 1.619 |
| | vd | 46 | 47 |
| | Tg (° C.) | 380 | 430< |

The glass of the present invention showed a much lower transformation temperature (Tg) than the comparative glass did, although they were almost the same in terms of both the refractive index (nd) and the Abbe number (vd).

### Example 3

As an index of chemical durability, the water-resistance of a glass composition (Composition No. 11 in Example 1) of this invention was compared with that of another glass that included 18 wt % of Li₂O (glass corresponding to the glass described in Example 10 and in Japanese Unexamined Published Patent Application No. H04-23 1345).

The test was conducted by measuring the weight loss of the optical glass, which had been crashed to grains of 420 μm-590 μm in size, after being soaked in boiling deionized water for 60 minutes. The results thereof are shown in Table 5.

TABLE 5
A Comparison of a Glass of This Invention with Another Glass

| | | Glass of This | Other Glass |
|---|---|---|---|
| | | Invention | (for comparison) |
| Glass | Li₂O | | 1.8 |
| composition | Na₂O | 6.6 | 4.4 |
| (wt %) | K₂O | 4.1 | 4.1 |
| | ZnO | 18.2 | 8.9 |
| | CaO | | 6.1 |
| | BaO | 19.5 | 16.8 |
| | SrO | | |
| | MgO | | |
| | P₂O₅ | 41.5 | 43.5 |
| | Sb₂O₃ | 8.8 | |
| | Al₂O₃ | 1.3 | 0.4 |
| | SnO | | |
| | PbO | | 13.7 |
| Properties | nd | 1.602 | 1.603 |
| | vd | 52 | 53 |
| | Weight loss (wt %) | 0.0409 | 0.0729 |

The results show that the optical glass of this invention had less weight loss (wt %) than the other glass, which means that the optical glass of this invention had higher chemical durability than did the other glass.

1. An optical that has a glass transformation temperature (Tg) of 340° C.-430° C., comprising:
(a) Na₂O in an amount ranging from 4 wt % to 12 wt %;
(b) ZnO in an amount ranging from 9 wt % to 38 wt %;
(c) P₂O₅ in an amount ranging from 38 wt % to 57 wt %; and
(d) Sb₂O₃ in an amount ranging from 2 wt % to 17 wt %.

2. An optical glass that has a transformation temperature (Tg) of 340° C. to 430° C., and that is comprised of:
(a) Na₂O in an amount ranging from 4 wt % to 12 wt % or Na₂O and K₂O in a combined total amount ranging from 4 wt % to 12 wt % under the condition that K₂O is in an amount less than 7 wt %;
(b) ZnO and oxides selected from CaO, BaO, SrO, and MgO in a combined total amount ranging from 21 wt % to 45 wt %, under the condition that ZnO is from 9 wt % to 38 wt % and said oxides are 9 wt % or less of CaO, 31 wt % or less of BaO, 15 wt % or less of SrO, and 8 wt % or less of MgO;
(c) P₂O₅ in an amount ranging from 38 wt % to 57 wt %; and
(d) Sb₂O₃ in an amount ranging from 5 wt % to 17 wt %.

3. The optical glass of claim 1, further comprising Al₂O₃, SrO, ZrO₂, TiO₂, Nb₂O₅, WO₃, B₂O₃, La₂O₃, Y₂O₃ or Gd₂O₃.

4. The optical glass of claim 1, further comprising SiO₂, Bi₂O₃, Yb₂O₃ or GeO₂.

5. The optical glass of claim 1, having a refractive index (nd) of from 1.56516 to 1.61161.

6. The optical glass of claim 1, having an Abbe number (vd) of 40.4-58.9.

7. The optical glass of claim 1, having a glass transformation temperature (Tg) of 345° C. to 426° C.

8. The optical glass of claim 1, having a glass transformation temperature (Tg) of 345° C. to 408° C.

9. The optical glass of claim 2, further comprising Al₂O₃, SrO, ZrO₂, TiO₂, Nb₂O₅, WO₃, B₂O₃, La₂O₃, Y₂O₃ or Gd₂O₃.

10. The optical glass of claim 2, further comprising SiO₂, Bi₂O₃, Yb₂O₃ or GeO₂.

11. The optical glass of claim 2, having a refractive index (nd) of from 1.56516 to 1.61161.

12. The optical glass of claim 2, having an Abbe number (vd) of 40.4-58.9.

13. The optical glass of claim 2, having a glass transformation temperature (Tg) of 345° C. to 426° C.

14. The optical glass of claim 2, having a glass transformation temperature (Tg) of 345° C. to 408° C.
